(19) United States
(12) Patent Application Publication
(10) Pub. No.: US 2007/0250491 A1
(43) Pub. Date: Oct. 25, 2007

(54) Method for referencing image data

(76) Inventors: Artur G. Olszak, Tucson, AZ (US); Michael R. Descour, Tucson, AZ (US); James Goodall, Tucson, AZ (US)

Correspondence Address: BIRDWELL & JANKE, LLP, Suite 1400, 1100 SW Sixth Avenue, Portland, OR, 97204, US

(21) Appl. No.: 11/818,556

(22) Filed: Jun. 14, 2007

Related U.S. Application Data
(63) Continuation of application No. 10/666,633, filed on Sep. 18, 2003, now abandoned.
(60) Provisional application No. 60/412,601, filed on Sep. 18, 2002.

(51) Int. Cl. G06F 17/30; G06F 15/00

(52) U.S. Cl. 707/3; 715/501.1

(57) ABSTRACT

A method for referencing image data. Preferred methods include methods for linking, characterizing, searching, and navigating the image data, as aids to reviewing the image data.

### CROSS REFERENCE TO RELATED APPLICATION

This application claims the benefit of the applicants' provisional application Ser. No. 60/412,601, and is a continuation application of U.S. Ser. No. 10/666,633, filed Sep. 18, 2003, both of which are incorporated by reference herein in their entirety.

### FIELD OF THE INVENTION

This invention relates to a method for referencing image data. More particularly, the invention relates to linking, characterizing, searching, and navigating the image data as aids to reviewing the image data.

### BACKGROUND

There are many reasons for acquiring image data, and many uses for image data. One important example of such reasons and uses is found in medical pathology. A pathologist must examine tissue samples at high magnification to assess and diagnose disease conditions. To create an image record of a tissue sample, a microscope used for viewing the tissue sample is equipped with a digital camera to capture digital image data representative of the tissue sample at high resolution. Owing to the inherent trade-off between the field of view (FOV) of the typical single-optical-axis microscope and the microscope's resolution, image data are typically obtained by stepping over the tissue sample to acquire a series of relatively small image tiles that must ultimately be “stitched” together to achieve a high resolution image of the entire tissue sample. Alternatively and preferably, the recently developed multi-axis array microscope can be used to acquire a high resolution image record of an entire tissue sample in one continuous scan of the tissue sample.

In any event, one pathologist in one hospital may generate a large number of image records of tissue samples. Moreover, pathologists in one hospital may want to share image records with pathologists in another hospital, to locate areas within the image records that are of mutual interest or concern, to converse about the image records, and to create and share textual annotations to the image records. For example, Bacus, U.S. Pat. No. 6,396,941 proposes a number of combinations of such transactions. Similar needs arise in the context of generating, organizing, evaluating, and sharing image data obtained in other ways and used for other purposes.

A number of unmet needs remain. Pathologists often want to recall one tissue sample that is similar in some respect to another tissue sample. They often want to add location specific data to the tissue sample and selectably retrieve the data, and the desired data may be of any type. They may want to create the data themselves, have the data created under high level command, or have the data created automatically. Further, the pathologist reviewing image data needs to navigate image data as quickly and efficiently as possible. The prior art has offered little or no assistance to the pathologist in any of these regards.

Accordingly, there is a need for a method for reviewing image data that addresses the aforementioned needs as well as others, in pathology and in any other field in which image data are generated, organized, evaluated, or shared.

Objects, features and advantages of the invention will be more fully understood upon consideration of the following detailed description, taken in conjunction with the following drawings.

### BRIEF DESCRIPTION OF THE DRAWINGS

FIG. 1 is a pictorial view of an exemplary microscope array imaging system for acquiring image data for use according to the present invention.

FIG. 2 is a schematic view of a viewing station for viewing image records according to the present invention.

FIG. 3 is a flow chart of a method for creating electronic links between and within image records according to the present invention.

FIG. 4 is a schematic view of the organization of an image-server log according to the present invention.

FIG. 5 is a flow representation of a data miner for use according to the present invention.

FIG. 6 is a flow representation of an image handling program according to the present invention.

FIG. 7 is a diagrammatic representation of hubs and authorities for use in a link-based searching methodology according to the present invention.

FIG. 8 is a Venn diagram of a subcollection of image records according to the present invention, showing the image record contents for the subcollection, and “in-pointing” image records pointing to the image record contents and image records “pointed-to” from the image record contents.

FIG. 9 is a schematic view of a viewing screen for viewing image data and identifying electronic links according to the present invention.

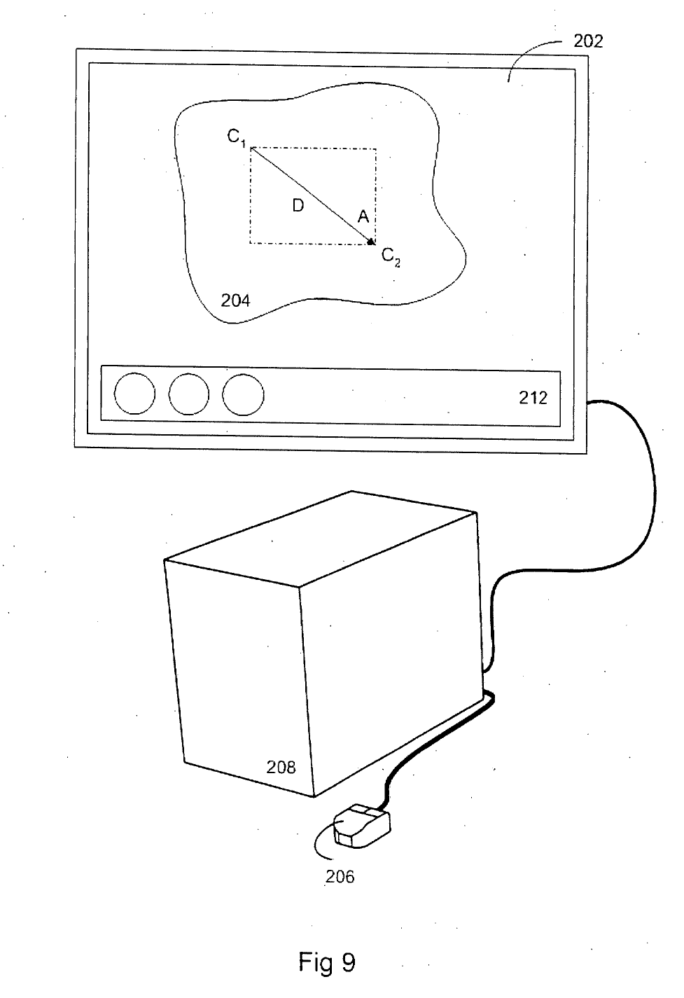

### DETAILED DESCRIPTION

A method for referencing image data according to the present invention produces and employs image records. An image record includes image data, i.e., pixels, and related data, termed herein “metadata.” For an image record of a pathology slide, examples of metadata are slide information (e.g., a bar code, thumbnail image, indication of the stain(s) used), image attributes (e.g., magnification, site, date and time of creation, image size), image information (e.g., average nucleus size, annotations), and displaying information (e.g., coordinates, resolution, rendering options).

The pixels are typically defined by their size, spacings, and locations on the image, and by component values such as intensity (or amplitude), optical density, red, green and blue. Metadata according to the present invention can be data in any form, e.g., text, spreadsheet, voice, audio, still-images (e.g., an image taken at a “grossing station” that shows the location from which a tissue specimen was excised), graphics, and video. Text and voice entries may preferably be convertible from one to the other by means of software at a reviewing station, at a transmitting station for transmitting the image record or at a receiving station for receiving the image record.

In pathology, an image record is an image of a particular tissue sample obtained by a biopsy, typically the entirety of the sample that is mounted to a microscope slide. Metadata for the image record would typically include, at least, patient identification data, and data indicating the general location from which, and the date on which, the biopsy was taken.

The image record may also be an image of a collection of tissue samples arranged on a single microscope slide, e.g., a “tissue microarray,” (TMA) including tissue cores distributed in a two dimensional pattern on the microscope slide. Metadata for a tissue microarray would typically include, at least, header information with data elements that provide basic information about the file (creator, date created, etc.), block information with data elements that describe the TMA block (how many cores, how large are the cores, how the cores arrayed in the block, etc.), slide information with data elements that describe the slides prepared from the TMA block (how the slides are stored, how the slides are identified, etc.), and all data related to the individual tissue samples contained in the array (e.g., the case from which the core came, the block in the case used to make the core, the drill-site in the block that was used, the diagnosis of the drill-site, the clinical history associated with the core, demographic information associated with the patient from whom the core was taken, etc.).

All of the image records of a set of image records define an image record collection. Particular image data or metadata within an image record may be referred to as a data object. While pathology applications will be discussed throughout this specification, it should be understood that the concepts apply to image data generally; on the other hand, it is believed that that the invention is particularly advantageous for use in pathology and that it addresses needs that have not heretofore been recognized in this particular application.

According to the invention, image records are referenced generally by electronic links. Two types of electronic links are employed. A “hyperlink” in the context of the present invention is an electronic link providing access, from one distinctively marked place or location in an image record, to another place or location in the same or a different image record. A second type of electronic link according to the present invention is termed herein a “roll-over” link, which does not provide for accessing one location from another, but merely “popping-up,” at one location, data that is obtained from another location. Typically, a “roll-over” link is activated merely by moving a cursor to a particular location on a display screen, while a hyperlink is activated by clicking at the location. A clickable icon may be provided that may be hidden until revealed when the cursor rolls over the icon, or the region on the display associated with the icon. Alternatively, the icon may be viewable when the cursor is at other locations on the display screen. For many purposes, no icon is needed, and simply clicking at the particular location may activate a hyperlink whose identification is either unnecessary or is clear from context.

Typically, electronic links according to the present invention are provided between image data and metadata, but electronic links between image data and hyperlinks between metadata may also be provided without departing from the principles of the invention.

Electronic links are composite objects defined by attributes which may also exist as metadata for the image record. For hyperlinks, exemplary attributes include the coordinates, resolution and image file/record name of the location at which the portal to the link exists (“representation location”), the coordinates, resolution and image file/record name of the location to which the link connects the user when the hyperlink is activated (“target location”), the coordinates and image file/record name of the location, representation information (e.g., whether the hyperlink is indicated by a box, icon, text, combination thereof, etc.), and annotation information, i.e., information that describes the hyperlink such as the target and intention. For roll-over links, the metadata is simply annotation information.

Preferred embodiments of the invention may be broadly categorized as providing one or more of the following features: (1) creating electronic links to or from (hereinafter “in”) one or more image records for navigating the image records; (2) searching image records using electronic links; (3) searching image records directly; (4) anticipating navigation patterns to enhance navigating speed; and (5) additional features.

Regarding (1), electronic links can be created in three basic ways: (a) directly; (b) based on the history of how one or more viewers have previously navigated the same or similar image data; and (c) based on computation of parametric data characterizing the image data.

Each of these features is described separately below, it being understood that any combination of one or more of the features may be employed as desired.

As mentioned above, the invention pertains particularly to referencing image data, and more particularly, digital image data, though digital image data may be derived from analog data if necessary. Image data obtained for use in pathology is typically obtained using a microscope in conjunction with a digital camera. However, it should be understood that image data for use in accord with the principles of the invention may be provided by any imaging system, and may be used for any purpose.

In conventional, single-axis, microscopes, optical resolution must be traded off with the microscope's field of view (“FOV”) i.e., the FOV must be decreased in order to increase the resolution. Typically in pathology, the required resolution makes it impractical to image an entire microscope slide in one snap-shot using a single-optical-axis microscope. Therefore, a microscope with an objective having a small FOV is typically provided with a motorized stage for scanning the specimen. The motorized stage translates microscope slides to, sequentially, move one portion of the specimen into a field of view of the microscope and then another, to obtain respective image portions of the specimen. An image of the entire specimen, or selected portions greater than the microscope's field of view, may be assembled from the image portions in a process known as “tiling.”

This scanning is time-intensive. Moreover, the tiling process associated with this scanning exacts penalties in speed and reliability. Tiling requires computation overhead, and severe mechanical requirements are placed on the stage, e.g., to translate from one location to another accurately and to settle quickly for imaging, or tile alignment errors may be difficult or impossible to accurately correct. A most serious source of error results from differences in alignment between a line of sensors used for recording an image tile and the direction of horizontal slide transport provided by the scanning system.

Recently, a multi-axis imaging system has been developed employing an array of objectives defining a multi-axis imaging system wherein the optical axes of the objectives are not collinear. Adapted for microscopy, the array is miniaturized to form a miniature microscope array (“microscope array”). The microscope array may be used to scanningly image one object, or to simultaneously scanningly image multiple objects, in which case the microscope array may, be more illustratively termed an array microscope. For purposes herein, there is no distinction intended between these two terms.

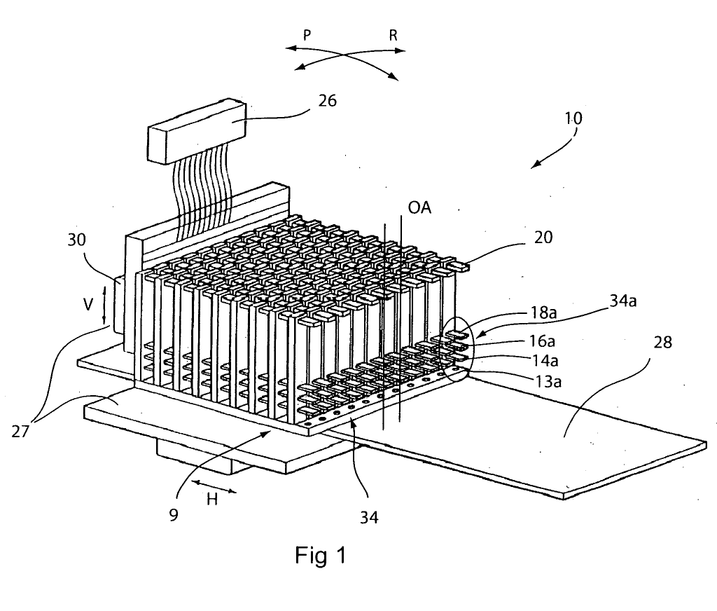

FIG. 1 shows a microscope array 10 for scanning an object 28, which is shown as a microscope slide. A tissue specimen (not shown) is mounted on the microscope slide. The microscope array comprises an optical system 9 that includes groups 34a of objectives, the objectives including any number of optical components such as lenses, polarizers, stops and apertures 114a, 116a, and 118a. Optical axes OA of the objectives are shown parallel, for imaging a planar object, but the axes may not be parallel if it is desired to image a non-planar surface.

Associated with each objective 34a are digital image sensors 20 that are typically CCD or CMOS arrays. Since the objectives are larger than their associated fields of view, a two-dimensional array of objectives is required to completely scan a one-dimensional line across the specimen, and data from the image sensors must be ordered appropriately to accurately assemble the data into a composite image.

A computer 26 controls a scanning mechanism 27 for translating the object in the direction “H,” and a height-tilt/tip adjustment mechanism 30 for focusing the array and adjusting pitch and yaw to accommodate any tilt and tip of the object.

The microscope array is able to obtain a microscopic image of all, or a large portion, of a relatively large specimen or object, such as the 20 mm×50 mm object area of a standard 1″×3″ microscope slide. This is done by scanning the object line-by-line with an array of optical elements having associated arrays of detectors. An image of the entire object can be obtained during a single, continuous scan of the object, providing an outstanding advantage in imaging speed.

The optical elements are spaced a predetermined distance from one another, and the entire array and object are moved relative to one another so that the positional relationship between image data from the detectors is fixed, and data are thereby automatically aligned. This provides the outstanding advantage of eliminating the need for tiling or stitching, reducing errors as well as computation overhead.

For all of these reasons, a multi-axis imaging system such as the microscope array is preferred for obtaining image data. Many of the features provided by the present invention become particularly advantageous where the speed and accuracy of the multi-axis imaging system is utilized. However, it is reiterated that any imaging system may be used to obtain image data for use in accord with the principles of the invention. It should also be understood that, while microscopes are examples of imaging systems for use in pathology, and that such examples are used throughout this specification by way of example and by way of describing preferred embodiments of the invention, other imaging systems used in other contexts or for other purposes may be employed, along with demagnification or no magnification as well as magnification.

Where a microscope array is used, the image record will typically include seamless image data that represents a complete, high resolution, viewable image of the entirety of a tissue specimen. A viewer may request a subset of the image record to view a desired portion or segment of the tissue, saving transmission time, or the entire record may be transmitted if desired. The resolution at which the image is displayed may also be varied according to user demand, potentially further saving transmission time. The image data may be compressed at the sending station and decompressed at the receiving station to yet further save transmission time.

Where a single-axis microscope is used, images are acquired in “tiles.” The tiles are stored along with x and y coordinates corresponding to the location on the tissue specimen which the tile image represents. Unless a desired portion or segment of the tissue happens to be contained within a single tile, multiple tiles generally need to be selected, transmitted, and “stitched” together as is well known in the art. Image data for an image record may be limited to tiles, or tiles may be combined to form composite image data for a composite image record.

Methods according to the present invention may be used in conjunction with collaborations between different “agents,” which may be any combination of persons and computer programs. For example, a person agent may collaborate with a remote computer agent, e.g., on the Internet, to decide collaboratively whether a particular hyperlink should be created, or whether particular metadata, such as a diagnosis, be modified or appended. The computer agent in this example may also select image records for review and highlight features in the selected image record that are of potential interest. The person agent may in collaboration produce a diagnosis that is added by the computer agent to the metadata for the image record. Collaboration may be provided for any desired purpose, such as education and training, quality assurance, and obtaining second opinions. In providing for collaborations between agents, different agents may be assigned different operating privileges to operate on the image record, e.g., to read only selected portions of an image record, to read all of an image record, to write to only selected portions of an image record, to write to any portion of an image record, to create an image record, or to delete an image record. It is often particularly useful for collaborating between agents to provide for all of the agents to access the same portions of the same image record at the same resolution and with the same renderings substantially simultaneously.

An agent may seek to link multiple image records according to a predefined characteristic of the tissue that is imaged. Image records linked in this manner may represent a representative sampling of pathology specimens to be evaluated by another agent for the purpose of quality assurance. In another example, image records may be linked based on similarity in an image characteristic, such as whether different tissue samples exhibit the same stage of lesion development or progression toward a malignant state as described in U.S. Pat. No. 6,204,064. In yet another example, image records may be linked based on an image characteristic such as the value of a variable indicative of lesion progression toward a malignant state being within a predefined range, or representing sequential points on a lesion-progression curve, also as described in the '064 patent.

Image records that are linked together may be treated as whole “image record collections” that can be retrieved virtually as a unit from a number of different storage sites over which the individual image records are distributed.

Once image records are linked, the set of linked images may be communicated via a communication channel, such as the Internet, to another agent.

(1) Creating Electronic Links

According to the invention, there are three general methodologies for creating electronic links. In a first methodology, a viewer of the image record creates a desired electronic link. In a second methodology, the history of navigating one or more image records can be used to create desirable electronic links in the one or more image records themselves. Alternatively, the history can be used to infer desirable electronic links to create in similar image records for which a navigation history may not have yet been established. In a third methodology, location specific metadata is created for the image record and predefined parameters quantitatively indicative of conditions of interest are computed and correlated, for constructing electronic links that are likely to be desired by viewers in the future.

(a) Direct Creation of Electronic Links

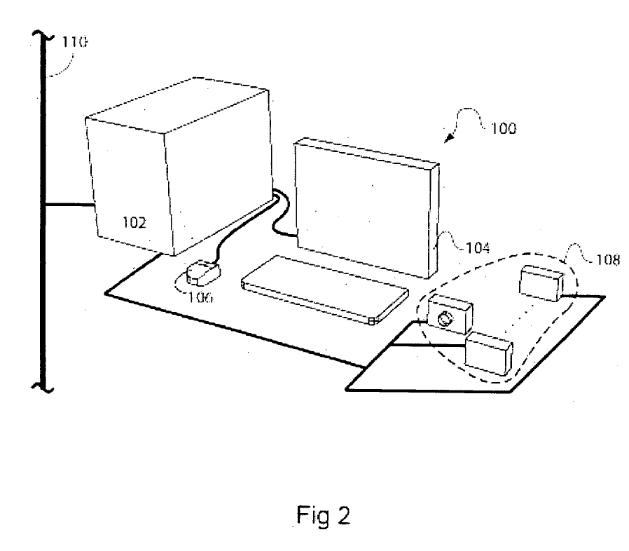

Referring to FIG. 2, a viewing station 100 is shown. The viewing station 100 includes a computer 102 for retrieving image records, a display 104 for displaying the image records, a mouse or other pointing device 106 for signaling locations on the display, and one or more input devices 108 for entering metadata. The type of input devices employed depends on the type of metadata to be entered. The computer's hard drive may be used to input a word-processor program document or spreadsheet, and the computer can be used as a gateway to obtaining metadata of any type from another computer by being connected thereto on a local area network, an intranet, or the Internet. For local textual entry, a microphone (for voice) or a keyboard (for type) may be provided, or a CD player may be provided for other audio metadata. Still-images may be entered using a digital camera, a scanner, and still or video images may be entered using a DVD player or CD-ROM drive. For computer agents, such specialized input devices are generally not necessary.

Image records may be stored in the computer 102, or may be available through a communications channel 110, such as by being stored in a server connected on a local area network to the computer 102, or stored at a remote transmitting location that transmits the image records to the computer 102 over the Internet.

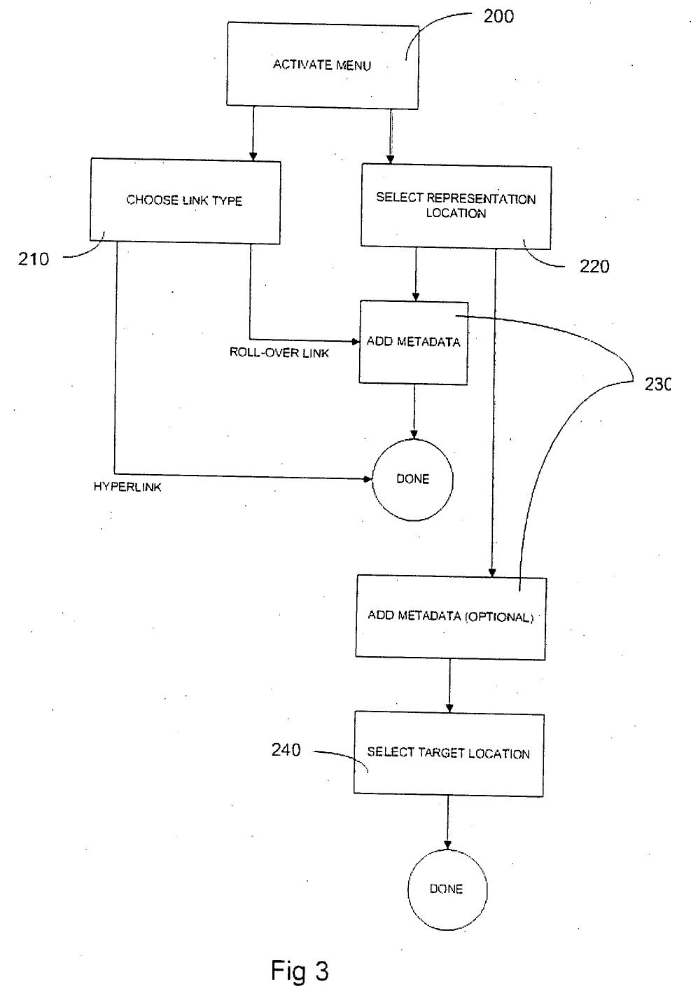

Electronic links may be directly created by an agent associated with the station 100 by use of a computer program for the computer 102 adapted generally as follows, with reference to FIG. 3. The method is described in the context of a person agent, where modification for a computer agent will be readily apparent.

A predefined keystroke, or sequence of keystrokes, or a predefined hyperlink, may be used to activate a menu (step 200). The menu provides a choice of creating a roll-over link or a hyperlink (step 210). In either case, a representation location is needed. A current View of an image record as it is or would be displayed on the device 104 (FIG. 2) is selected by the agent, and a particular location thereon is selected, such as by use of the mouse 106, as the representation location (step 220).

The representation location may be within image data, i.e., embedded within the image that is being viewed, so that it is directly accessible by pointing with the device 106, or, if the location is within metadata associated with particular image data, the metadata is called, such as either by clicking on a hyperlink or by rolling over a roll-over link, to call the representation location. Completion of the step of selecting the representation location may be signaled by a predefined keystroke or sequence of keystrokes in conjunction with pointing with the mouse, or simply by clicking the mouse.

Metadata associated with the representation location may also be added (Step 230). For a roll-over link, the addition of metadata completes link creation. For a hyperlink metadata may be desirable to identify or define the hyperlink from the representation location. The agent may signal the end of entry of metadata with another predefined keystroke, or series of keystrokes, or clicking a “back” or “finish” hyperlink.

A target location must also be selected for creating a hyperlink (step 240). The target location may be in the current View, or the target location may need to be called independently of the current View, or the target location may be called utilizing metadata accessible from the current View, e.g., existing hyperlinks accessible from the current View. Completion of the step of selecting a target location may be signaled by a predefined keystroke or sequence of keystrokes in conjunction with pointing with the mouse, or simply by clicking the mouse.

While the target attributes for the hyperlink are fixed, all of the other attributes may be modified to facilitate copying or formatting the hyperlinks. For example, an agent may wish to define a similar hyperlink to a given target location for three different image records, so that the representation location can be relocated when the hyperlink is copied.

Default iconic or textual metadata may be provided by the computer program as options selectable by the viewer.

The aforedescribed computer program includes an image viewing routine for displaying image data corresponding to a given View. The viewing program also parses the metadata corresponding to the image data to identify icons, text, or sub-images, where provided, for any electronic links. The metadata is rendered according to viewing options provided to the viewer, and may be superimposed over the image data in the appropriate location as specified by the representation and target location attributes where desired.

Where a first electronic link has a representation location that is outside the current View, metadata for the first electronic link may be posted or listed on the display, e.g., as a bookmark which provides a second electronic link or route to the representation location for the first electronic link.

Persons of ordinary skill in the electrical and computer arts will readily appreciate that various manners of programming the aforedescribed functions may be used, and that various hardware implementations may equivalently be used, whether in conjunction with a computer or not.

(b) Creating Electronic Links Based on Navigation History

According to the invention, each image record is administered by an image server. The image server may be the local computer to which a peripheral display is connected for viewing an image record, or the image server may be remotely located and connected to the local computer by a local area network, intranet, or the Internet.

The image server logs all or a sub-set of all of an agent's activities pertaining to the viewing of an image file into an image-server log (hereinafter “navigation”). Examples of information stored in the image-server log are agent identification, time-stamps, particular data objects of the image record(s) that are visited, the representation location within the image record, and query terms used in searching.

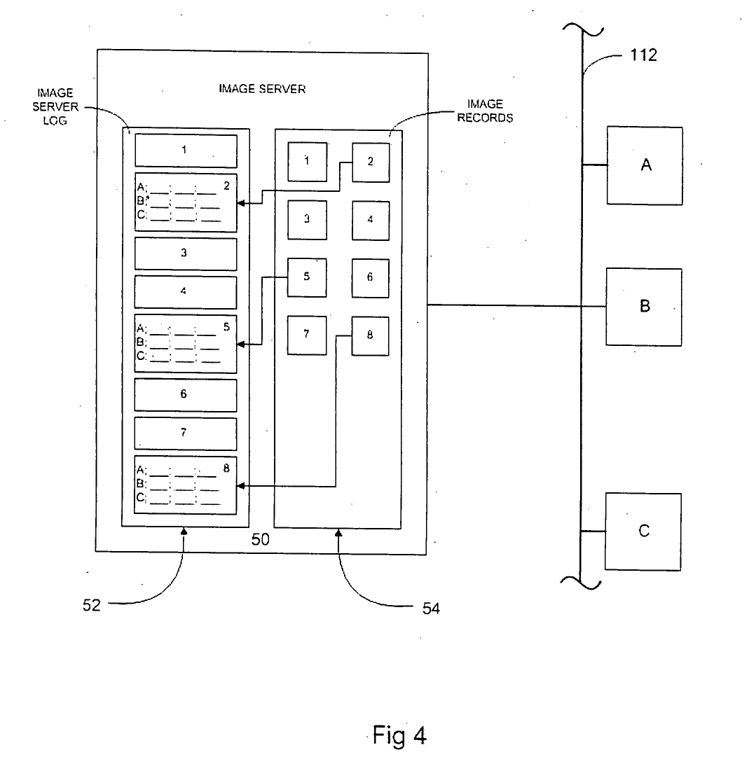

The image-server log may be organized as a collection of files individually associated with corresponding image records as shown in FIG. 4. An image server 50 includes an image-server log 52 and image records 54. Shown are 8 image records 1-8, and the image-server log has 8 corresponding partitions. Client servers A, B, and C are connected to the image server 50 through a network 112 which may be any network. The client servers A, B, and C navigate the image records and a history of their navigation(s) is maintained in the image-server log as indicated.

The image records may be and are preferably segmented with respect to predefined conditions or characteristics. For example, the image records may be segmented as a database according to (a) organ site, (b) histochemical stains used on the specimens, (c) visually assigned grade, (d) visual diagnosis, (e) image resolution, (f) diagnosis or grading by different expert diagnosticians, (g) expression of specific diagnostic criterion, (h) interval of diagnostic clue expression for one or several clues, (i) location, e.g., distance from the margin of a lesion, (j) tissue type, e.g., glandular tissue, stroma, or epithelium, (k) patient anamnestic data such as age, etc. This segmentation permits identifying all of the image records having a particular condition or characteristic, so that the image records can be searched for the condition or characteristic and gathered together for analysis or viewing. The image-server log may be encrypted.

The image-server log may be data-mined according to the present invention to determine high-frequency sequences of navigation. The determined sequences of navigation for past image records having related conditions or characteristics may be used to estimate navigation that may be desirable in future image records having the same conditions or characteristics. This information can be used by any agent, but preferably by a computer agent to automate the method, to construct electronic links in the future image records. As mentioned above, the history of navigating one or more image records can be used to create desirable electronic links in the one or more image records themselves; alternatively, the history can be used to infer desirable electronic links to create in similar image records for which a navigation history may not have yet been established.

A number of techniques exist for data-mining. For purposes herein, the technique known as “sequence mining” provides for identifying a navigational sequence according to the present invention. Sequence mining of the image-server log will reveal patterns of navigation of single or multiple image records, with the objective of determining frequent navigational patterns, e.g., individual navigation steps that occur frequently in the same order, or frequent patterns that contain no subpatterns that are also frequent (so-called “maximal frequent sequences”).

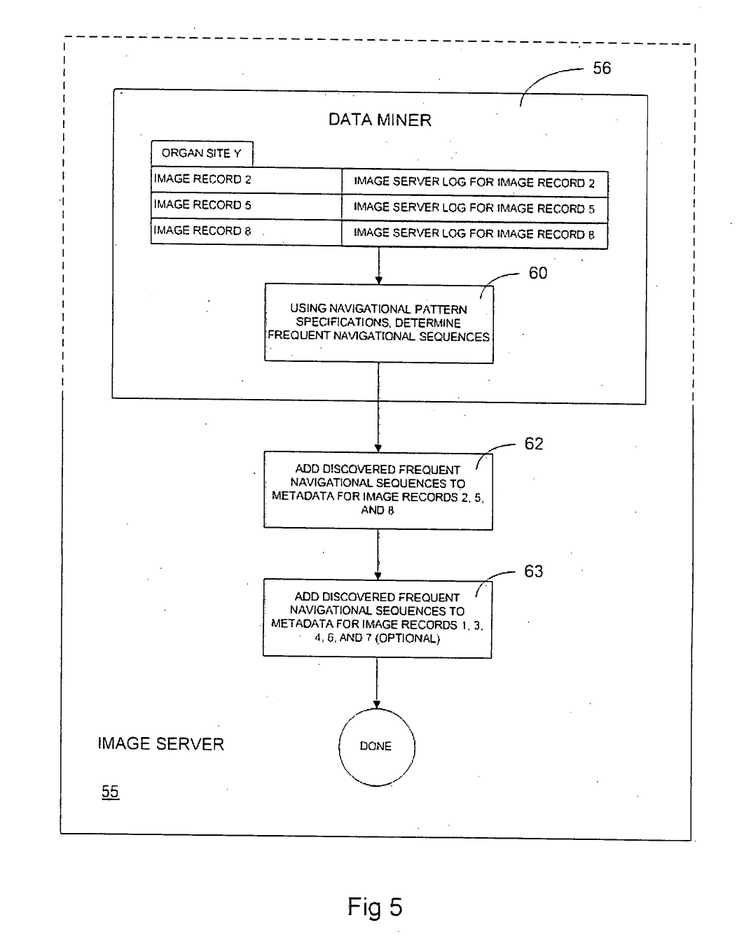

As an example of the use of data mining, referring to FIG. 5, a data mining program or data miner 56 may segment the data according to organ site, in consideration of the navigation histories for image records pertaining to that organ site, here image records 2, 5 and 8 (FIG. 4) pertaining to organ site Y. The data miner discovers the frequent sequences in the image-server log (step 60) for data pertaining to organ site Y. An image server program 55 then adds the frequent sequences discovered in the navigation histories of image records 2, 5, and 8 to the metadata of those image records (step 62). The image server program may also add those frequent sequences to the metadata of those image records pertaining to the organ site Y for which there is no navigation history, i.e., image records 1, 3, 4, 6, and 7 (step 63). The data mining program 56 may be part of the image server program 55 or a stand-alone application.

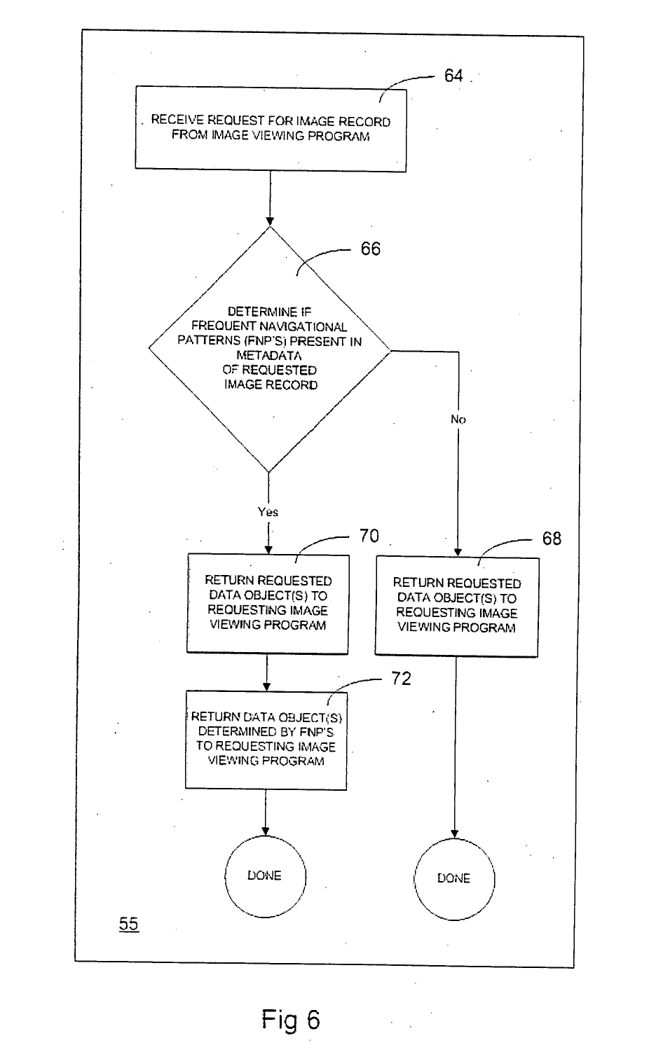

Turning to FIG. 6, in a step 64, the image server program 55 receives a request for image records associated with the organ site Y, e.g., image record 4, for which no navigation history exists, from one of the clients A, B, or C in FIG. 4. The image server program 55 determines (step 66) whether the metadata of image record 4 contain any frequent navigational patterns associated with the organ site Y, as discovered by data mining of any navigation histories associated with image records for the organ site Y, e.g., image records 2, 5, and 8 (FIG. 4). If the metadata of image record 4 contain no such frequent navigational patterns, then the image server program returns the requested data objects to the requesting image viewing program (step 68). If the metadata of image record 4 contain such frequent navigational patterns, then the image server program returns the requested data objects to the requesting image viewing program (step 70), and pre-fetches the next data object or a number of next data objects determined by the frequent navigational patterns and transmits those next data objects to the image viewing program (step 72) to accelerate navigation in case the client follows a frequent navigation pattern.

In one particular form of sequence mining, an agent may query the image-server log to identify all of the sequences, or determine the total number of sequences, that match a predefined or agent-specified navigational pattern or sequence. The agent may specify, for example, that the sequence of interest begins at a certain location (i.e., certain image data and metadata) within an image-record, that the sequence contains a condition or characteristic (e.g., indicative of lesion) at another location within the image record, and that the sequence does not include any location within the image record that contains a different condition or characteristic (e.g., indicative of normal tissue).

Sequence mining has been performed in the context of data-mining Web pages by using a program known in the computer arts as MiDAS (Mining Internet Data for Associative Sequences). The agent can specify the minimum and maximum length of a sequence or navigation pattern and the minimum and maximum time gap between two hits. The data input for MiDAS is a sorted set of navigations, which contains a primary key (for example, customer ID, cookie ID, etc.), a secondary key (date and time related information, e.g., login time), a sequence of hits, and which holds the actual data values (for example URLs). According to the present invention, the image record would be analogous to a Web page in the MiDAS environment. The image-server log would be analogous to a web log.

In another particular form of sequence mining, for each location within an image-record, a tree is constructed comprising all of the routes taken to reach a given location. The agent can distinguish between popular and rarely chosen routes to the location by noting the number of occurrences of each route on the tree. The agent can also identify ending locations at which navigation is frequently ceased or given up, by noting locations for which a popular route connects to a rarely followed route.

An example of this technique also in the context of data-mining Web pages is known as the Web Utilization Miner (WUM). In this algorithm, a data-mining query searches for template navigation patterns between image records. An example template may be of the form “a*b.” At the outset, the variables “a” and “b” are not bound to any specific image record. The symbol “*” is a “wildcard,” allowing for any number of image records to be visited between image records “a” and “b.” Additional specifications can be added to the data-mining query: For example, a first image record should be visited by at least a specified percentage, e.g., 30%, of the users recorded in the image server log. Of that percentage, at least another specified percentage, e.g., 40% (of the 30%), of users should reach a second image record. The first image record and the second image record need not be contiguous. Other image records may be allowed to be part of the route between the first and second image records, i.e., there may be multiple routes that link the two image records. The data-mining program then identifies from the image-server log all pairs of a first image record and a second image record that match the specified template navigation pattern. The multiple routes may also be identified.

Other examples of sequence mining of image-server logs can be implemented, for example, using the Perl programming language.

Navigation or usage patterns can be associated with any image-record segmentations, such as those indicated above. For example, frequently used navigation patterns can be determined for a particular diagnostician. Where the diagnostician is highly expert, this information can be used to develop expert system software. Navigation patterns are often desirably determined in conjunction with more than one segment, such as the patterns for the three segments: (a) diagnostician and (b) organ or (c) tissue type.

The navigation patterns determined using data-mining techniques may be used according to the present invention to pre-fetch data as in the example above, and to create new electronic links in similar or associated image records, where appropriate associations of image records can be recognized as a result of the segmentation methodology described above.

(c) Creating Electronic Links Based on Computation

According to the invention, desirable electronic links between or within image records can be determined by characterizing the data in the image records and linking data having the same or similar characteristics. Just as mentioned above in the context of creating electronic links based on history, the image records may be segmented as a database according to (a) organ site, (b) histochemical stains used on the specimens, (c) visually assigned grade, (d) visual diagnosis, (e) image resolution, (f) diagnosis or grading by different expert diagnosticians, (g) expression of specific diagnostic criterion, (h) interval of diagnostic clue expression for one or several clues, (i) location, e.g., distance from the margin of a lesion, (j) tissue type, e.g., glandular tissue, stroma, or epithelium, (k) patient anamnestic data such as age, etc. This segmentation permits identifying all of the image records having a particular condition or characteristic. Desirable electronic links can be identified from this segmentation for construction between or within image records. For example, all image records associated with a particular organ site, e.g., the prostate, may be selected for creating electronic links.

Parametric characterizations can also be made of image data and metadata, such as discussed below in the context of direct searching, as metadata added to the image record(s). Desirable electronic links can be identified from this metadata for construction between or within image records. The electronic links themselves are stored as metadata in the image record(s). The electronic links can be automatically generated from metadata.

A useful method for parametric characterization of data, at least in the context of histopathologic analysis, is the so-called N-gram methodology. An N-gram is a string of N elements, each of which can assume one of several fixed values. N-gram encoding is attractive due to its high sensitivity and extreme specificity. In document retrieval, strings of N=1-6 typically are used, with each element representing one of the letters of the alphabet. In the application to histopathologic imagery, the elements of the string are adjacent pixels in the image, and the different values are the optical-density (OD) values of these pixels. The OD range can be divided into several intervals for OD values ranging from 0.00 to approximately 1.80. N-grams, in fact, represent short sequences of OD gradients. To implement N-gram encoding, an image is divided into 64 by 64 pixels squares. A 64 by 64 pixel dimension of the square subregion is deemed a reasonable compromise, offering acceptable recognition rates and providing sufficient spatial resolution for a coarse lesion outline. N-grams are computed for N=4, i.e., for sequences of 4 pixels. For each 64 by 64 pixel region, N-grams are read in sequentially as a single 4-pixel string, advancing one pixel at a time, and wrapping around at the end of each row to the beginning of the next row. Using three OD intervals, N-gram encoding results in a feature vector of 81 values representing relative frequencies of occurrence. Each 64 by 64 pixel region is therefore associated with an 81-element feature vector. The ith element of that vector corresponds to the ith possible N-gram and the value of the ith element is the number of instances of that type of N-gram that was encountered within the 64 by 64 pixel square subregion. The 81-element feature vector is an example of calculated metadata that may be used to automatically generate hyperlinks.

An example method of automatic generation of electronic links relies on accomplishing a hierarchical clustering of the image-records and their contents in the collection. This clustering may extend to the level of data objects in an image record, resulting in hyperlinks between parts of an image record, e.g., parts of an image, in addition to hyperlinks between separate image records. In the case of the N-gram computation, it is possible to create electronic links at the level of the 64 by 64 pixel subregions.

An exemplary hierarchical clustering technique is the graph-theoretic method. The graph-theoretic method is an example of a nonparametric clustering technique. A nonparametric clustering technique can form clusters even when boundaries between the clusters cannot be described by a parametric structure such as a hyperplane or a quadratic surface; hence the designation. In this approach, each data object that is characterized by a feature vector (e.g., an 81-element N-gram feature vector, as described above) is interpreted as a point in a high-dimensional scatter plot. Clusters are formed by creating links from a first data object in the scatter plot to a second data object. The algorithm begins at a first data object in the scatter plot and computes the local average of data objects contained in a hypervolume centered on the first data object. The local average of data objects is expressed as an average of the differences between each data object contained in the hypervolume and the first data object. In order to choose the second data object (so-called “predecessor”), differences between each data object contained in the hypervolume and the first data object are calculated. Each difference, which retains the vector form associated with the data objects, is then multiplied, element by element, by the local average of data objects. The element by element products are summed. The sum is normalized by the product of the square root of the sum of squares of the elements of the difference vector and the square root of the sum of squares of the elements of the local average vector. The data object that yields the greatest normalized sum of element-by-element products is chosen as the second data object. An electronic link from the first data object to the second data object is established. The algorithm now proceeds to the next first data object and the procedure is repeated until all data objects in the scatter plot have been processed thus.

The result of this algorithm is to produce a collection of links between data objects. Within a cluster, these links point to a final data object that is called the root data object. The root data object has only links pointing to it and no outgoing links.

A useful parameter in this approach to automatically generating electronic links between data objects is the size of the hypervolume. With a small hypervolume, the algorithm tends to find many clusters separated by local valleys that may be influenced by noise. On the other hand, if the hypervolume is too large, then the algorithm produces only one cluster. In order to find a proper size for the hypervolume, the algorithm needs to repeat its operations for various sizes of the hypervolume. As the size of the hypervolume is changed from a small value to a large value, the number of clusters starts from a large value, diminishes and stays at a certain level before diminishing again. The plateau at the intermediate range of hypervolume sizes is a reasonable and stable operating range from which an appropriate hypervolume size may be determined. The algorithm may include a procedure for identifying the appropriate hypervolume size as part of its operations.

The automatic generation of electronic links may be applied between data objects within a single image record, within a segment of a collection of image records, and up to including the entire collection of image records. All or a subset of the metadata associated with each image record may be utilized in the automatic generation of electronic links. At its simplest, the incorporation of additional metadata can be implemented by the concatenation of additional elements to the feature vector associated with data objects or entire image records.

(2) Searching Using Electronic Links

A search engine may be provided according to the present invention for searching in and among image records. An outstanding feature of the invention is to permit searching of image data and metadata that is nontextual by parametric characterization as discussed above. The invention also provides for ranking of image records by use of electronic links.

A search engine provided for information retrieval typically receives a user's queries and returns a list of data objects most closely matching or most similar to the search queries. Typically the search results, i.e., the data objects listed, are too numerous for a person to review, hence a ranking routine is provided to sort the results so that results at the beginning of the list are a more probable match than results near the end of the list. However, traditional, similarity-based methods of information retrieval often fail to filter sufficient numbers of irrelevant records.

In general, a user's query may be used to select from the image-record collection a subcollection of image records based on measuring the similarity between the query and available image records in the collection. For example, an image record or a data object can be associated with a set of parameters P, an m-dimensional vector, each element of the vector being a histogram bin associated with a parameter calculated from the image data. The number of contents of a histogram bin is divided by the sum of the contents of that histogram bin over the entire image-record collection. The query Q is also expressed as a vector of m elements. Similarity between P and Q is obtained via the angle between the two vectors, obtained from the inner product of these two vectors. Since every image record in the collection has associated with it one or more vectors P, the result of the search is a list of angles between the vectors P and the query vector Q. The user may set a maximum threshold on the computed angles. Image records for which the corresponding angle exceeds the specified maximum threshold are not considered as part of the set of search results. Image records for which the corresponding angle is less than or equal to the specified maximum threshold are included in the subcollection of image records corresponding to the user's query. The image records contained in the subcollection along with the links between them form a so-called sub-graph.

To improve the accuracy of information retrieval, the invention provides searching algorithms that take advantage of the interlinked nature of an image record collection. In one embodiment of this methodology, a “reference-and-citation” rank algorithm is provided that determines the priority of a data object based on the number of electronic links to the data object and from the data object. This embodiment does not consider the directionality of the links, i.e., whether the links point to a data object or from a data object. The greater the number of links associated with a data object, the higher is that data object's, priority among search results. The total number of electronic links to the data object and from the data object (“reference-and-citation score”) may be calculated for every data object in the image record collection prior to a search in response to a user's query taking place. Alternatively, the reference-and-citation score may be calculated for every data object within the sub-graph.

In another embodiment of the methodology, a “citation-rank” algorithm is provided that determines the priority of a data object also based on the number of electronic links to the data object. In this embodiment, however, the directionality of the links is explicitly considered and only those links that point to a data object influence its priority. The greater the number of links pointing to a data object, the higher is that data object's priority among search results. The total number of electronic links to the data object (“citation-rank score”) may be calculated for every data object in the image record collection prior to a search in response to a user's query taking place. Alternatively, the citation-rank score may be calculated for every data object within the sub-graph.

In a first variation of use of the citation-ranking methodology according to the present invention, a subcollection of image records is selected based on a thresholded similarity metric (e.g., angle between the query vector Q and the set of parameters vector P) is organized according to the number of hyperlinks that point to each image record in the subcollection. For example, a user searching for image data corresponding to a specified distance from the margin of a lesion in a specified organ will be presented first with an image record or an image-record segment that has the most hyperlinks pointing to it. The hyperlinks that point to the first result of the search may be themselves the results of automated hyperlink generation using metadata, may have been placed by a previous user, or may be the result of image-server log data mining. The remaining results of the search, i.e., image records contained in the subcollection, are presented in the order of decreasing number of hyperlinks pointing to each image record.

While citation-ranking is already an effective means of link-based ranking of search results, it does not account for the significance associated with the originating ends of the hyperlinks that point to a given image record.

In a second variation of use of the citation-ranking methodology according to the present invention, the citation-ranking algorithm is extended to capture the “importance” of an image record or a data object. The result is a ranking algorithm that uses the link structure between data objects to estimate the “importance” of the data object or the image record or the data object. In this variation, all links are not treated as equal. Instead, links from important data objects cause the importance of a data object to be enhanced more than those links from less important data objects. Therefore, the importance of a first data object depends on and influences the importance of other data objects to which the first data object is linked, so that a basic link-counting ranking (here citation-ranking) algorithm extended to encompass “importance” is recursive. The higher the measure of importance of a data object or an image record, the higher is its priority among search results.

The algorithm of this variation uses an adjacency matrix that records the existence of electronic links between image records or data objects. If a link exists between the ith image record and the jth image record, then a value of the inverse of the total number of links outgoing from the ith image record is entered in the (i, j) element of the adjacency matrix. If no link exists between the ith image record and the jth image record, then a value of zero (0) is entered in the (i, j) element of the adjacency matrix. In the case of the ith image record or data object with no outgoing links, the value of the inverse of the total number of image records and data objects in the image-record collection is entered in each (i, j) element of the adjacency matrix. The adjacency matrix is a square matrix with dimensions equal to the number of image records and data objects in the image-record collection. The “importance” or rank of the image records and data objects in the image-record collection is organized as a vector whose elements hold the “importance” value of the corresponding image record or data object. Formally, the importance vector is the principal eigenvector of the transpose of the adjacency matrix. Once the importance values of all image records and data objects are calculated, such information may be used to organize the results of a search query.

Practical calculation of the “importance” or rank vector follows an algorithm as outlined below in Table 1:

TABLE 1

```
Importance(A, e, a)
    A:  m rows by m columns adjacency matrix.
    e, a: natural numbers with the constraint that 0 < a < 1;
Let s denote an arbitrary random m-element vector
Let r denote the matrix-vector product A^{T} s.
If ||r−s|| > e then
    S = r
    r = a A^{T} s + (1−a)/m
Endif
End
Return r
```

The importance values contained in the returned vector r may be used to organize the image records and data objects found by a search algorithm in order of decreasing importance. The importance score may be calculated for every data object in the image record collection prior to a search in response to a user's query taking place. Alternatively, the importance score may be calculated for every data object within the sub-graph.

In still another embodiment of the methodology, a “hypertext induced topic search,” or HITS, algorithm is provided with a link analysis algorithm that produces two “scores” for a data object termed an “authority” score and a “hub” score. The scores are typically numeric, though this is not necessary and a symbolic or other scoring methodology could be used.

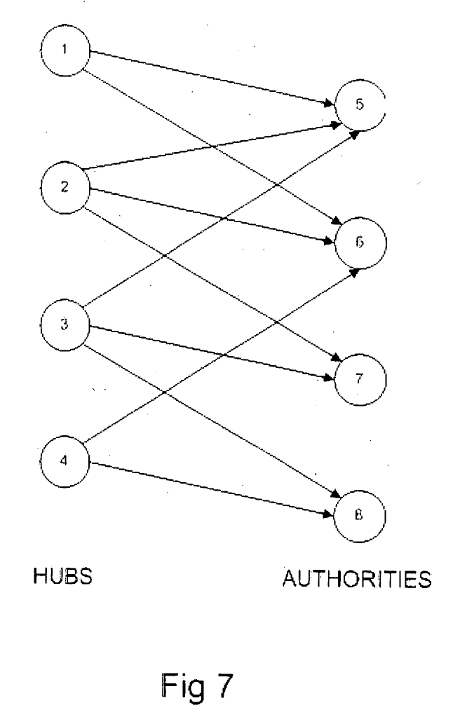

Authority image-records are those most likely to be relevant to a particular query. As illustrated in FIG. 7, the hub image records are those that are not necessarily authorities but point to several authority image records. The authority image records are not necessarily hubs but are pointed to by several hub image records. A mutually reinforcing feedback or recursive relationship exists between the hubs and authorities: An authority image record is an image record that is pointed to by many hubs and hubs are image records that point to many authorities.

An “authority” image record may be interpreted, for example, as an image record or a data object that represents a textbook example of a specific medical condition. Given that interpretation, authority image records may be of particular use in the context of medical education. A “hub” image record or data object may be an image record or a data object corresponding to an early stage of progression towards cancer. That hub image record or data object could then point to authority image records or data objects that correspond to various later stages of progression. Alternatively, a “hub” image record or data object may be one that contains ambiguous characteristics and be linked to other image records or data objects that provide the user with references to possible interpretations of the ambiguous characteristics observed in the hub.

In a variation of use of the HITS methodology according to the present invention, a subcollection of image records returned by the search algorithm is expanded. The expansion of the subcollection is determined by the link structure associated with the subcollection. The subcollection should preferably satisfy three criteria: (1) the subcollection is relatively small compared to the entire image-record collection, (2) the subcollection is rich in image records relevant to the query, and (3) the subcollection contains most or many of the strongest authorities. The subcollection returned by the similarity based search may satisfy these three criteria in its nominal form. Criterion (1) may be satisfied by specifying a maximum number of image records ranked by increasing angle calculated by the similarity-based search algorithm to be included in the subcollection.

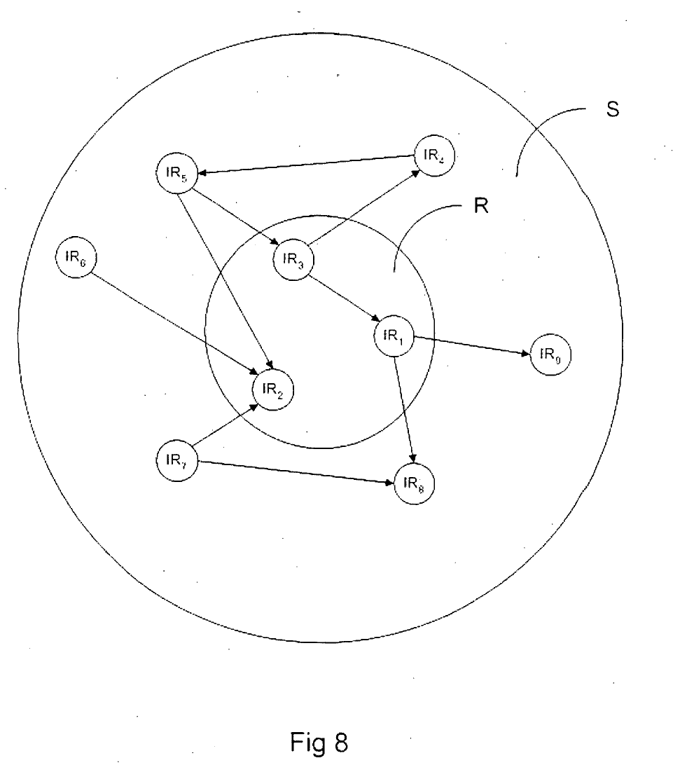

FIG. 8 shows a subcollection sub-graph “R” containing image records “IR₁,” “IR₂,” and “IR₃” returned by a similarity-based search algorithm and the links associated with those image records. Preferably, prior to computing the authority and hub scores, the contents of the subcollection are expanded by including image records outside the subcollection pointed to by the image records in the sub-graph “R,” as well as any image records “IR₄,”-“IR₉” outside the subcollection that point to an image record within the sub-graph. However, the number of “in-pointing” image records (“IR₄,”-“IR₉”) may need to be restricted to less than a threshold number in order to prevent the expanded subcollection from becoming too large and no longer satisfying criterion (1). The expanded subcollection forms a new sub-graph “S.”

In more formal terms, the following algorithm (Table 2) may be employed to expand the subcollection of image records and obtain an expanded sub-graph:

TABLE 2

| Expand(σ, E, t, d) | |
|---|---|
| σ. | a query, expressed as a vector of parameters P. |
| E: | a vector-based search algorithm. |
| t, d: | natural numbers. |

```
    Let R_{σ} denote the top t results of E on σ.
Set S_{σ} := R_{σ}
For each image record j ∈R_{σ}
    Let Γ⁺(j) denote the set of all image records that j points to.
    Let Γ⁻(j) denote the set of all image records that point to j.
    Add all image records in Γ⁺(j) to S_{σ}.
    If |Γ⁻(j)|≦ d, then
        Add all image records in Γ⁻(j) to S_{σ}.
    Else
        Add an arbitrary set of d image records from Γ⁻(j) to S_{σ}.
End
Return S_{σ}
```

The authority and hub scores are calculated from the expanded sub-graph of image records obtained with Expand (σ, E, t, d). The sub-graph before or after expansion as outlined above may include one or more data objects associated with a single image record.

To implement the hub and authority score methodology, an algorithm is provided that considers the links pointing to a first data object and those pointing from the first data object separately. Links from important data objects to the first data object increase the first data object's authority score. Links from the first data object to important data objects increase the first object's hub score. Data objects can be ranked in priority according to the authority score, according to the hub score, or a combination thereof.

Hub and authority scores can be computed directly as the principal eigenvectors of matrices derived from an adjacency matrix A. The elements of the adjacency matrix A express the presence or absence of a link between two image records or data objects. If a link is present between data object i and data objectj, then a “1” is entered at position (i, j) within the adjacency matrix. If no link is present between data object i and data object j, then a zero (0) is entered at position (i, j) within the adjacency matrix. The hub scores for all image records within the query-driven subcollection are contained within the principal eigenvector of the matrix formed by the product AA^{T}. The principal eigenvector may be calculated numerically using commercial software such as MATLAB or IDL or by means of numerical methods well known in the art. The authority scores for all image records within the query-driven subcollection are contained within the principal eigenvector of the matrix formed by the product A^{T}A. In the case of each type of score, the authority or hub score of the ith data object is the value of the ith element of the corresponding principal eigenvector. The direct computation of the principal eigenvectors may not be practical if a query results in a large subcollection of image records. In that case, an iterative algorithm may be employed that converges to the desired authority and hub scores.

The algorithm begins by assigning arbitrary values to all hub and authority scores, e.g., all values are set to unity. If an image record points to many image records with high authority scores, then it should receive a high hub score. Conversely, if an image record is pointed to by many image records with high hub scores, then it should receive a high authority score. This pair of relationships may be formalized by assigning to image recordj's authority score the sum of the hub scores of the image records that point toj. The image recordj's hub score is set to the sum of the authority scores of the image records thatj points to. After this pair of operations is performed, the hub scores and the authority scores of all image records in the subcollection are normalized so that their squares sum equals unity, i.e., Σᵢaᵢ²=1 and Σᵢhᵢ²=1, where aᵢ is the authority score of the ith image record or data object in the subcollection and hᵢ is the hub score of the ith image record or data object in the subcollection. This iterative process continues until the relative ranking of image records in the subcollection according to descending authority and hub scores is stable. Further iterations may be employed in order to arrive at a progressively better approximation of the principal eigenvectors associated with the hub scores and the authority scores, as explained above.

Hub and authority scores computed for each image record in a subcollection can now be used to reorder the image records. Image records or data objects in the subcollection have associated with them already an angle, quantifying similarity to the query vector Q. Image records in a subcollection may be recognized as authorities based on exceeding a threshold authority score. Image records in a subcollection may be recognized as hubs based on exceeding a threshold hub score.

(3) Direct Searching

According to the invention, image data are made searchable by characterizing the image data in terms of searchable parameters, e.g., numbers or text, which are added to the image record(s) as metadata. Preferably, for use in pathology, the method provides for characterizing the image data in terms of image characteristics, such as, for example, the optical-density values of each pixel, or the intensity or color value of a variable indicative of lesion progression.

It may be desirable, when computing image characteristics for image data, to consider the properties of the specimen and the imaging instrument, e.g., the stains used on the specimen or the light source and magnification used to image the specimen. For example, the detection of nuclei in an image based on color may consider variations in the staining associated with nuclei as well as the emission spectrum of the light used to transilluminate the specimen if the image data are acquired on different instruments or the specimen is processed at different facilities.

It may also be desirable, when computing image characteristics for image data, to consider the spatial resolution of the data and the relative sizes of features in the image data that are of interest. For example, in the aforementioned N-gram calculation, the N-gram feature vectors are associated with 64×64 pixel subregions. Thence, a 1024×1024 pixel image is reduced to 16×16 blocks, each block being associated with one N-gram feature vector. A lesion that may be contained in the image and be distinguished by the N-gram feature vectors may be therefore only coarsely outlined. Depending on the size of the lesion, a smaller image subregion size, e.g., 32×32 pixels, may be preferred.

Once data are characterized, searching parameters or text may be done as is ordinary in the computer arts, e.g., by using Boolean operators on conditional statements. A computer program is adapted to interface with an agent for the purpose of accepting search criteria for identifying the desired image data, identifying one or more image records in which to search for the desired image data, and carrying out the search. The search criteria may be that the searched variable matches the parameter determined for the image data, or that the searched variable falls within a range for the parameter. Multi-variable searches may also be conducted using the same methods. Image data found in a search may be highlighted in a current View of the image data, e.g., by colorizing the image data and/or the metadata associated therewith.

The program may also provide for searching metadata. For textual or numeric metadata, searching may be accomplished as is standard in the art. Audio metadata may be converted to text and searched in the same manner. Graphic, iconic, still-image and video metadata may be searched in the same manner as image data, by parametrically characterizing the graphics, icon, still-image or video metadata in any manner that is appropriate for distinguishing the metadata and identifying the desired metadata. A arbitrary coding could be used for different icons, graphics, pictures or video sequences if desired, rather than a quantifiable variable such as is ordinarily desired for searching image data.

(4) Enhancing Navigation Speed

As explained above, data-mining techniques can be used to recognize appropriate new electronic links for image records that are related to or associated with existing image records for which image-server log data has been obtained. The same techniques can be used to enhance navigation speed. The navigation patterns may be used to predict what part of an image record or image records an agent is most likely to access next. The prediction can be used to anticipate the agent's request by retrieving a set of the most likely image records for ready display when the request is made, thereby accelerating the response of the aforedescribed image record viewing routine.

(5) Additional Features—Smart Pointer

A smart pointer according to the present invention facilitates the retrieval of metadata associated with an image region within the image record. As discussed above, an icon used to identify a hyperlink has associated therewith a particular group or set of pixel locations to which the cursor may point to activate the electronic link. A roll-over link has a similar group of associated pixel locations. The set or group of pixel locations is typically relatively small. It may be desired to identify all of the links within a larger area, or greater number of pixels. Referring to FIG. 7, showing a viewing screen 202 for viewing image data 204 of an image record, such an area “A” may be identified by clicking a mouse 206 while dragging the mouse along the diagonal “D.” The mouse is connected to a computer 208. A computer program running in the computer 208 notes the coordinates “C₁” and “C₂” defining the area A as transmitted by the mouse. The computer program retrieves all of the data associated with roll-over links and all of the hidden icons associated with hyperlinks in the area, and displays the data and icons in a defined location on the viewing screen 212. It is preferable to provide icons for hyperlinks where the smart pointer feature is desired, so that the computer program possesses displayable information to reveal the existence of the hyperlink and, preferably, its function.

Any of the methods described herein as well as other methods according to the present invention may be implemented using a general purpose computer executing a software program of instructions. Alternatively and equivalently, the methods may be implemented using hardware or a combination of hardware and software as will be readily apparent to those of ordinary skill.

Further, programs of instructions may be provided to perform methods according to the present invention. Such programs of instruction are embodied in media, such as one or more hard disks, floppy disks or CD-ROMs, that are readable by a machine such as a general purpose computer. For this purpose, computers such as those described above for use with the present invention may include one or more drives appropriate for reading machine readable media.

Programs of instruction according to the present invention may provide for the implementation of methods according to the present invention by a computer agent in conjunction with one or more actions or steps taken by a human agent, or such programs may enable computer agents to perform complete methods. In that connection, the term “reviewing” as used in the claims is intended to mean either viewing by a human agent, or the equivalent if performed by a computer agent.

It is to be recognized that, while particular methods for referencing image data have been shown and described as preferred, other methods may be employed without departing from the principles of the invention.

The terms and expressions that have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow:

1. A method for referencing image data, comprising the steps of:
reviewing a portion of the image data;
based on said reviewing, selecting from within said portion a point of reference; and
creating an electronic link between said point of reference and another portion of the image data.

2. The method of claim 1, wherein at least one of the steps of the method is executed by a computer.

3. The method of claim 2, further comprising a machine readable medium embodying a program of instructions executable by the computer to perform said at least one of the steps of the method.

4. The method of claim 1, wherein said link is a roll-over link, the method further comprising adding metadata to the image data.

5. The method of claim 1, wherein said link is a hyperlink, wherein said hyperlink points to said other portion of the image data.

6. The method of claim 1, further comprising producing at least one image record within which are a plurality of electronic links, and searching for data objects within the image records connected by said links by examining said links.

7. The method of claim 6, wherein said step of examining includes computing respective metrics derived from said links for said data objects.

8. The method of claim 7, wherein said metrics are citation-rank scores, the method further comprising ordering said data objects according to the respective said citation-rank scores.

9. The method of claim 7, wherein said metrics are importance scores, the method further comprising ordering said data objects according to the respective said importance scores.

10. The method of claim 7, wherein said metrics include at least one of hub and authority scores, the method further comprising ordering said data objects according to the respective said at least one of hub and authority scores.

11. The method of claim 1, further comprising producing a plurality of image records between which are a plurality of electronic links, and searching for data objects connected by said links by examining said links.

12. The method of claim 11, wherein said step of examining includes computing respective metrics derived from said links for said data objects.

13. The method of claim 12, wherein said metrics are citation-rank scores, the method further comprising ordering said data objects according to the respective said citation-rank scores.

14. The method of claim 12, wherein said metrics are importance scores, the method further comprising ordering said data objects according to the respective said importance scores.

15. The method of claim 12, wherein said metrics include at least one of hub and authority scores, the method further comprising ordering said data objects according to the respective said at least one of hub and authority scores.

16. The method of claim 1, further comprising pre-fetching said other portion of the image data as a result of recognizing the existence of said electronic link.

17. The method of claim 1, further comprising creating a second electronic link in another image record as a result of recognizing the existence of said electronic link.

18. The method of claim 17, further comprising pre-fetching a data object as a result of recognizing the existence of said electronic link.

19. The method of claim 1, further comprising producing at least one image record within which are a plurality of electronic links, determining from among a plurality of navigation sequences for navigating said image record one or more most frequent navigation sequences, and pre-fetching a data object as a result of recognizing said one or more most frequent navigation sequences.

20. The method of claim 1, further comprising producing at least one image record within which are a plurality of electronic links, determining from among a plurality of navigation sequences for navigating said image record one or more most frequent navigation sequences, and creating a new electronic link as a result of recognizing said one or more most frequent navigation sequences.

21. The method of claim 1, further comprising producing a plurality of image records between which are a plurality of electronic links, determining from among a plurality of navigation sequences for navigating said image records one or more most frequent navigation sequences, and pre-fetching a data object as a result of recognizing said one or more most frequent navigation sequences.

22. The method of claim 1, further comprising producing a plurality of image records between which are a plurality of electronic links, determining from among a plurality of navigation sequences for navigating said image records one or more most frequent navigation sequences, and creating a new electronic link as a result of recognizing said one or more most frequent navigation sequences.

23. The method of claim 1, further comprising parametrically characterizing said portion of image data to obtain a characterizing vector, and searching for said portion by comparing said characterizing vector with a predetermined query vector.

24. A method for referencing image data, comprising producing at least one image record within which are a plurality of electronic links to the image data, and searching for data objects within the image records connected by said links by examining said links.

25. The method of claim 24, wherein at least one of the steps of the method is executed by a computer.

26. The method of claim 25, further comprising a machine readable medium embodying a program of instructions executable by the computer to perform said at least one of the steps of the method.

27. The method of claim 24, wherein said step of examining includes computing respective metrics derived from said links for said data objects.

28. The method of claim 27, wherein said metrics are citation-rank scores, the method further comprising ordering said data objects according to the respective said citation-rank scores.

29. The method of claim 27, wherein said metrics are importance scores, the method further comprising ordering said data objects according to the respective said importance scores.

30. The method of claim 27, wherein said metrics include at least one of hub and authority scores, the method further comprising ordering said data objects according to the respective said at least one of hub and authority scores.

31. A method for referencing image data, comprising producing a plurality of image records between which are a plurality of electronic links to the image data, and searching for data objects connected by said links by examining said links.

32. The method of claim 31, wherein at least one of the steps of the method is executed by a computer.

33. The method of claim 32, further comprising providing a machine readable medium embodying a program of instructions executable by the computer to perform said at least one of the steps of the method.

34. The method of claim 31, wherein said step of examining includes computing respective metrics derived from said links for said data objects.

35. The method of claim 34, wherein said metrics are citation-rank scores, the method further comprising ordering said data objects according to the respective said citation-rank scores.

36. The method of claim 34, wherein said metrics are importance scores, the method further comprising ordering said data objects according to the respective said importance scores.

37. The method of claim 34, wherein said metrics include at least one of hub and authority scores, the method further comprising ordering said data objects according to the respective said at least one of hub and authority scores.

38. A method for referencing image data, comprising producing at least one image record within which are a plurality of electronic links, determining from among a plurality of navigation sequences for navigating said image record one or more most frequent navigation sequences, and pre-fetching a data object as a result of recognizing said one or more most frequent navigation sequences.

39. The method of claim 38, wherein at least one of the steps of the method is executed by a computer.

40. The method of claim 39, further comprising providing a machine readable medium embodying a program of instructions executable by the computer to perform said at least one of the steps of the method.

41. A method for referencing image data, comprising producing at least one image record within which are a plurality of electronic links, determining from among a plurality of navigation sequences for navigating said image record one or more most frequent navigation sequences, and creating a new electronic link as a result of recognizing said one or more most frequent navigation sequences.

42. The method of claim 41, wherein at least one of the steps of the method is executed by a computer.

43. The method of claim 42, further comprising providing a machine readable medium embodying a program of instructions executable by the computer to perform said at least one of the steps of the method.

44. A method for referencing image data, comprising producing a plurality of image records between which are a plurality of electronic links, determining from among a plurality of navigation sequences for navigating said image records one or more most frequent navigation sequences, and pre-fetching a data object as a result of recognizing said one or more most frequent navigation sequences.

45. The method of claim 44, wherein at least one of the steps of the method is executed by a computer.

46. The method of claim 45, further comprising providing a machine readable medium embodying a program of instructions executable by the computer to perform said at least one of the steps of the method.

47. A method for referencing image data, comprising producing a plurality of image records between which are a plurality of electronic links, determining from among a plurality of navigation sequences for navigating said image records one or more most frequent navigation sequences, and creating a new electronic link as a result of recognizing said one or more most frequent navigation sequences.

48. The method of claim 47, wherein at least one of the steps of the method is executed by a computer.

49. The method of claim 48, further comprising providing a machine readable medium embodying a program of instructions executable by the computer to perform said at least one of the steps of the method.

50. A method for referencing image data, comprising parametrically characterizing said portion of image data to obtain a characterizing vector, and searching for said portion by comparing said characterizing vector with a predetermined query vector.

51. The method of claim 50, wherein at least one of the steps of the method is executed by a computer.

52. The method of claim 51, further comprising providing a machine readable medium embodying a program of instructions executable by the computer to perform said at least one of the steps of the method.

53. A machine readable medium embodying a program of instructions executable by the machine to perform a method for referencing image data, the method comprising:
reviewing a portion of the image data;
based on said reviewing, selecting from within said portion a point of reference; and
creating an electronic link between said point of reference and another portion of the image data.
